(19) United States
(12) Patent Application Publication
(10) Pub. No.: US 2026/0331134 A1
(43) Pub. Date: Oct. 22, 2026

(54) SMART DEPLOYMENT OF ADAPTIVE FEATURES

(71) Applicant: Seagate Technology LLC, Fremont, CA (US)

(72) Inventors: Qiang BI, Singapore (SG); Xiong LIU, Singapore (SG); Mingzhong DING, Singapore (SG)

(21) Appl. No.: 19/183,601

(22) Filed: Apr. 18, 2025

(51) Int. Cl. G11B 5/596

(52) U.S. Cl. CPC G11B 5/59627

(57) ABSTRACT

A servo control system may, during a tuning period, detect at a data storage device, position error signals for one or more read-write heads of the data storage device. The servo control system may generate a disturbance profile for the data storage device based on the position error signals, the disturbance profile indicating the disturbances detected at the data storage device. The servo control system may determine a set of adaptive features to mitigate one or more of the disturbances indicated in the disturbance profile. The servo control system may deploy the set of adaptive features in servo code of the data storage device for positioning of the one or more read-write heads of the data storage device.

### BACKGROUND

Recent developments in storage device technology, including increased tracks per inch (TPI) and reduced on cylinder limits (OCLIM), have required an increase in the servo sampling rate of a servo system, which is responsible for positioning the read/write head of the storage device. For example, the servo system of the storage device adjusts the head's position based on servo feedback samples. The servo sampling rate is the frequency at which the servo system samples or measures the position of the head relative to the disk surface and produces a position error correction accordingly. Accordingly, the time given for the servo system to detect and compensate for disturbances (e.g., vibrations) has been reduced.

### SUMMARY

In some aspects, the techniques described herein relate to a method for mitigating disturbances detected at a data storage device, including: during a tuning period, detecting, at the data storage device using a servo control system, position error signals for one or more read-write heads of the data storage device; generating, using the servo control system, a disturbance profile for the data storage device based on the position error signals, the disturbance profile indicating the disturbances detected at the data storage device; determining, using the servo control system, a set of adaptive features to mitigate one or more of the disturbances indicated in the disturbance profile; and deploying, using the servo control system, the set of adaptive features in servo code of the data storage device for positioning of the one or more read-write heads of the data storage device.

In some aspects, the techniques described herein relate to one or more tangible processor-readable storage media embodied with instructions for executing on one or more processors and circuits of a computing device a process for mitigating disturbances detected at a data storage device, the process including: during a tuning period, detecting, at the data storage device using a servo control system, position error signals for one or more read-write heads of the data storage device; generating, using the servo control system, a disturbance profile for the data storage device based on the position error signals, the disturbance profile indicating the disturbances detected at the data storage device; determining, using the servo control system, a set of adaptive features to mitigate one or more of the disturbances indicated in the disturbance profile; and deploying, using the servo control system, the set of adaptive features in servo code of the data storage device for positioning of the one or more read-write heads of the data storage device.

In some aspects, the techniques described herein relate to a computing system for mitigating disturbances detected at a data storage device, the computing system including: one or more hardware processors; a disturbance profile generator stored in memory and executable by the one or more hardware processors and configured to: detect, during a tuning period at a data storage device, position error signals for one or more read-write heads of the data storage device; and generate a disturbance profile for the data storage device based on the position error signals, the disturbance profile indicating the disturbances detected at the data storage device; an adaptive features generator stored in memory and executable by the one or more hardware processors and configured to determine a set of adaptive features to mitigate one or more of the disturbances indicated in the disturbance profile; and an adaptive features parameters loader stored in memory and executable by the one or more hardware processors and configured to deploy the set of adaptive features in servo code of the data storage device for positioning of the one or more read-write heads of the data storage device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example computing environment in which a servo control system selects adaptive features for a storage device based on disturbances detected at the storage device.

FIG. 2 illustrates differences between an ideal trajectory and an actual trajectory of an example read/write head around a disk of a hard disk drive that occur due to disturbances at a location of the hard disk drive.

FIG. 3 illustrates an example disturbance profile for a storage device.

FIG. 4 illustrates an example computing environment in which a servo control system incorporates adaptive features parameter modifications for a set of adaptive features in servo code of a storage device based on disturbances detected at the storage device.

FIG. 5 illustrates an example computing environment in which a servo control system generates adaptive features for incorporation into servo codes of a plurality of storage devices based on disturbances at the plurality of storage devices.

FIG. 6 illustrates examples of operations for mitigating disturbances detected a storage device.

FIG. 7 illustrates an example computing device for implementing the described technology.

### DETAILED DESCRIPTION

The magnitude and frequency of disturbances in storage devices may vary depending on one or more fixed factors (e.g., HDD location in server enclosure) or dynamic factors (e.g., blade passing frequency (BPF) and harmonics matching structure frequencies when fan speed changes). Accordingly, disturbance profiles may differ drastically from one storage device to another.

Conventional servo control systems utilize servo code that includes parameters corresponding to a predefined set of adaptive features for addressing disturbances at the storage device. For example, disturbances can include fixed frequency disturbances (e.g., structure resonance modes in a cabinet or hard disk drive (HDD)) and varying frequency disturbances (e.g., blade passing frequency (BPF) and harmonics of fans). Adaptive features may include one or more adaptive control features. Adaptive features are sets of instructions (e.g., position error signal (PES) calculation instructions, control algorithms, etc.) utilized by the servo system to control actuators including a Voice Coil Motor (VCM) and/or microactuators of the storage device to adjust the read/write head position to compensate for the external disturbances. Due to the increased sampling rate and the limitation in adaptive feature computation time and code space, only a limited number of adaptive features can be deployed in the servo code. However, because the adaptive features are predefined, they are not able to compensate for different disturbance patterns of different storage systems.

The described technology provides adaptive features for inclusion in servo code, the adaptive features configured to address different disturbance profiles. In some implementations, the servo control system of the described technology performs a tuning process to generate a disturbance profile for the storage device and then provide adaptive features including parameters that compensate for a predetermined number of the greatest disturbances in the disturbance profile. In some implementations, the servo control system, after deployment of initial parameters in the servo code corresponding to an initial set of adaptive features, generates a subsequent disturbance profile for the storage device and modifies the parameters in the servo code to correspond to a subsequent set of adaptive features selected to address one or more disturbances of the subsequent disturbance profile.

In some implementations, based on a disturbance profile generated for a storage device, the described technology deploys adaptive features for the storage device and for one or more additional storage devices in the same cabinet as the storage device. Accordingly, the described technology provides adaptive features specifically targeted to disturbance profiles for the storage device and/or multiple storage devices in the same cabinet as the storage device, which better addresses disturbances than conventional servo code that includes a set of predefined adaptive features. The deployment of targeted adaptive features of the described technology enables storage devices to better compensate for disturbance in different cabinets than conventional servo code that includes a predefined set of adaptive features. Storage systems using the described technology are, therefore, better able to handle reduced OCLIM and increased TPI compared to conventional servo control approaches that use a predefined set of adaptive features.

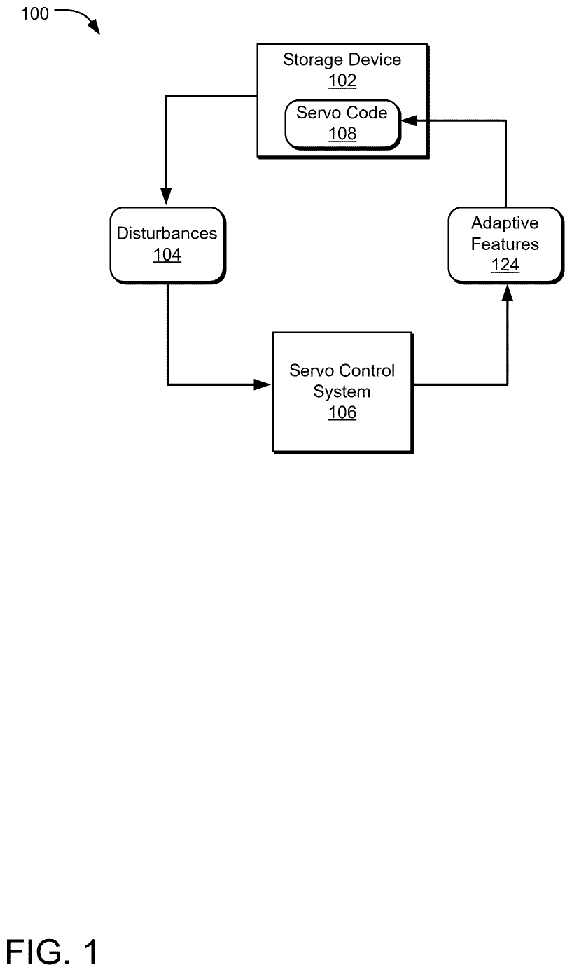

FIG. 1 illustrates an example computing environment 100 in which a servo control system 106 selects adaptive features 124 for a storage device 102 based on disturbances 104 detected at the storage device 102. The computing environment 100 includes a storage device 102 and a servo control system 106.

The storage device 102 is a hardware component, for example, a hard disk drive (HDD), designed to record, retain, and retrieve digital data, serving as a repository for files, applications, the operating system, and other data within the computing environment 100. The storage device 102 enables users to save information for immediate or future access. The storage device 102 includes disks (e.g., platters) coated with magnetic material and moving read/write heads that may access data from the disks. As the disks rotate, the heads pass over sections where the magnetic polarity indicates stored data. Reading data may involve the read/write heads sensing these magnetic transitions and converting them into binary data (or other data formats represented by the magnetic transitions). Writing data may involve the read/write heads altering the magnetic orientation of specific regions on the spinning disks. For example, each disk is coated with a thin magnetic layer divided into sections capable of being magnetized individually, and when data is saved, the read/write head, positioned just above the platter's surface, generates a magnetic field that reorients the magnetization of one or more of these regions. For example, binary data may be encoded as patterns of magnetic north and south poles.

The servo control system 106 is resident on the storage device 102. The servo control system 106 detects disturbances (e.g., detected disturbances 104) of the storage device 102. The disturbances may be detected in terms of a position error signal (PES) that measures, based on the read positioning signals, a difference between the actual and intended read/write head position of the storage device 102.

In some implementations, upon installation of the storage device 102 at the target location (e.g., the cabinet), the servo control system 106 performs a tuning operation to detect the disturbances 104 and to generate a disturbance profile for the detected disturbances 104 detected during the tuning operation. The servo control system 106 then selects adaptive features 124 to address disturbances of the disturbance profile for inclusion in the servo code 108 of the storage device 102. In some implementations, the servo control system 106 performs the tuning operation at a first location, selects the adaptive features 124 to address the disturbances 104 of the disturbance profile generated for the first location, incorporating the adaptive features 124 in the servo code 108, and then shipping the storage device 102 to the target location. For example, the first location is a testing location with a disturbance profile predicted to be similar to the disturbance profile of the target location. In some implementations, the servo control system 106 performs the tuning operation for the first storage device operating in a cabinet, selects the adaptive features 124 to address detected disturbances 104 of a disturbance profile generated for the first storage device, and then deploys the adaptive features 124 to the servo codes (e.g., the servo code 108) of one or more of the first storage device or other storage device(s) in the cabinet other than the first storage device.

The disturbances 104 may be caused by one or more vibrations present at the storage device 102 during the tuning operation. Disturbances 104 may include fixed and/or varying disturbances. The servo control system 106 may generate a disturbance profile (e.g., a disturbance spectrum) for the storage device 102 that describes the disturbances 104 based on the detected position error signals (PESs).

The disturbance profile may include one or more frequency zones/bands corresponding to the detected disturbances 104 that have characteristic energies or energy densities. For example, after the data storage device 102 is mounted in a slot of a cabinet, the servo control system 106 determines, using servo code, a PES disturbance profile. During the operation of the storage device 102, the servo control system 106 collects PESs and PES disturbances and clusters the disturbances 104. In some implementations, the read/write heads of a disk of the storage device 102 monitor (e.g., log) a current track upon which the read/write heads are operating and compare the current track to a target track. For example, a read/write head's target track is track 100 but, at times due to disturbances 104, the read/write head veers off track 100 onto track 99.9, track 100.1, track 99.8, etc. The PESs are determined based at least in part upon a difference between the current track and the target track for the read/write head. For example, a read/write head currently reading at track 99.9, where the target track is track 100, may detect a PES of −0.01 tracks. Generating the disturbance profile may involve Density-Based Spatial Clustering of Applications with Noise (DBSCAN), K means, or other clustering techniques to detect peak frequencies, bandwidths, and amplitudes of the disturbances 104 detected at the storage device 102. For example, the storage device 102 is caused to operate in its target environment (e.g., a cabinet including the storage device 102 and other storage devices) at a target fan speed and a target workload.

The servo control system 106, based on the disturbances 104, generates adaptive features 124 for inclusion in the servo code 108 for the storage device 102. Servo code 108 is integral to precisely positioning the read/write heads during data operations (e.g., read and write operations). Servo code 108 consists of patterns (e.g., one or more synchronization signals, track identifiers, offset signals, timing marks, etc.) embedded on the disks, serving as a reference for the actuator system of the storage device 102 to accurately locate and maintain the read/write heads over specific tracks. The servo code 108 enables the read/write heads to read/write data with precision, compensating for mechanical drift or vibrations (e.g., disturbances), ensuring reliability and efficiency.

The adaptive features 124 include instructions for the counteracting the disturbances 104 of the disturbance profile so that the read/write heads maintain the correct positioning during data operations despite the ongoing disturbances at the storage device 102.

To generate the adaptive features 124, the servo control system 106 determines from the disturbances 104 (e.g., the disturbance profile), a set of N adaptive features to address a set of N top disturbances of the disturbances 104. For example, selecting the N top disturbances includes ranking the disturbances 104 according to energy (or energy density) and then selecting the N disturbances with the greatest energy (or greatest energy density). In some implementations, the detected disturbances 104 are ranked according to amplitude or other criteria, and the N top disturbances are selected as the disturbances having the greatest amplitude or other criteria. For example, N is a specified number, such as four, ten, eight, twelve, or another specified number. The number N is configurable by an operator of the computing environment 100. For example, the greater the number N, the greater the space required to store the adaptive features 124 in the servo code 108, and the more effective the servo code 108 may be for addressing the disturbances 104 (e.g., because the adaptive features 124 address a greater number of disturbances). The lesser the number N, the lesser the space required to store the adaptive features 124 in the servo code 108 and the less effective the servo code 108 may be for addressing the disturbances 104 (e.g., because the adaptive features 124 address a lesser number of disturbances).

The N adaptive features 124 may be selected to address the N selected disturbances of the disturbances 104 based on the characteristics of the disturbances. The characteristics of the disturbances may indicate disturbance types. The servo control system 106 incorporates the N selected adaptive features 124 into the servo code 108. The adaptive features 124 may be selected based on a set of parameters in the disturbance profile, for example, frequency, bandwidth and depth. For example, the adaptive features 124 are selected to counteract the disturbances that are characterized by their frequency, bandwidth, and depth.

In some implementations, the servo control system 106 performs a tuning operation for an operating storage device 102 that already has a deployed set of adaptive features 124 and then generates a second set of adaptive features (different from the first set) to address disturbances 104 of a disturbance profile generated for the operating storage device 102 during the tuning period. Accordingly, the servo control system 106 may adapt the storage device 102 to changed disturbance profiles, for example, when the storage device 102 is moved to a new cabinet, or when the storage device 102 otherwise is exposed to new disturbance conditions.

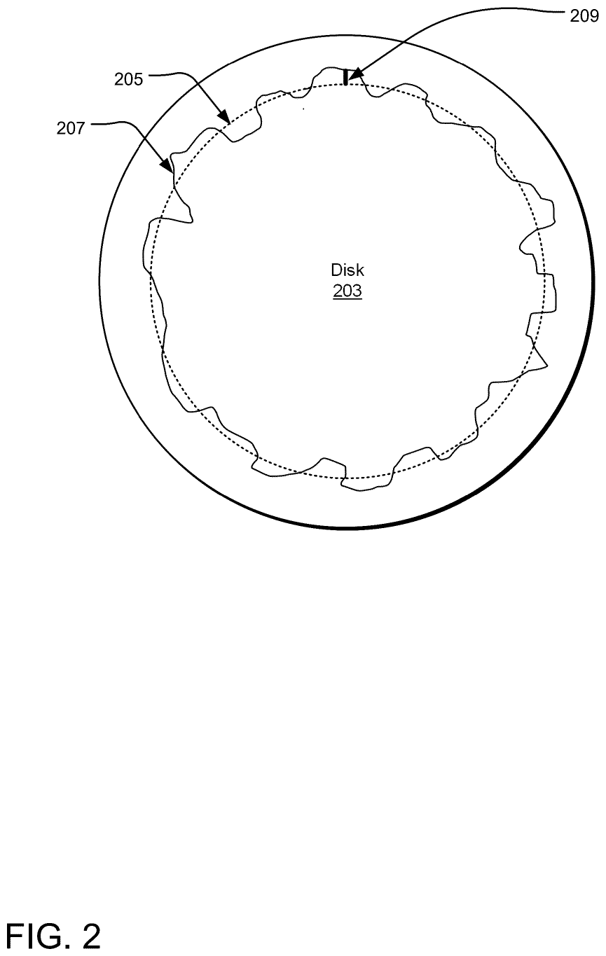

FIG. 2 illustrates differences between an ideal trajectory 205 and an actual trajectory 207 of an example read/write head around a disk 203 of a hard disk drive that occur due to disturbances at a location of the hard disk drive. The disk 203 is coated with magnetic material and the moving read/write head may access data from the disk 203 or write data to the disk 203. As the disk 203 rotates, the head passes over sections where the magnetic polarity indicates stored data. The ideal trajectory 205 of the head is indicated with a dotted line in the example disk 203 of FIG. 2. However, due to disturbances at the location of the storage device that includes the disk 203, the head is not able to follow the ideal trajectory 205 along the disk 203 and instead follows the actual trajectory 207. For example, disturbances cause the head to divert from the ideal trajectory 205. During the operation of the storage device, the servo control system 106 collects PESs. For example, the PESs are based on a difference (e.g., difference 209) between the current position of the head and the corresponding position along the ideal trajectory 205 where the head should be located. The PESs may be expressed in terms of a number of tracks (e.g., the current track position is 77 and the ideal track position is 79), a distance, or other measure. The PESs may be clustered by the servo control system to generate a disturbance profile.

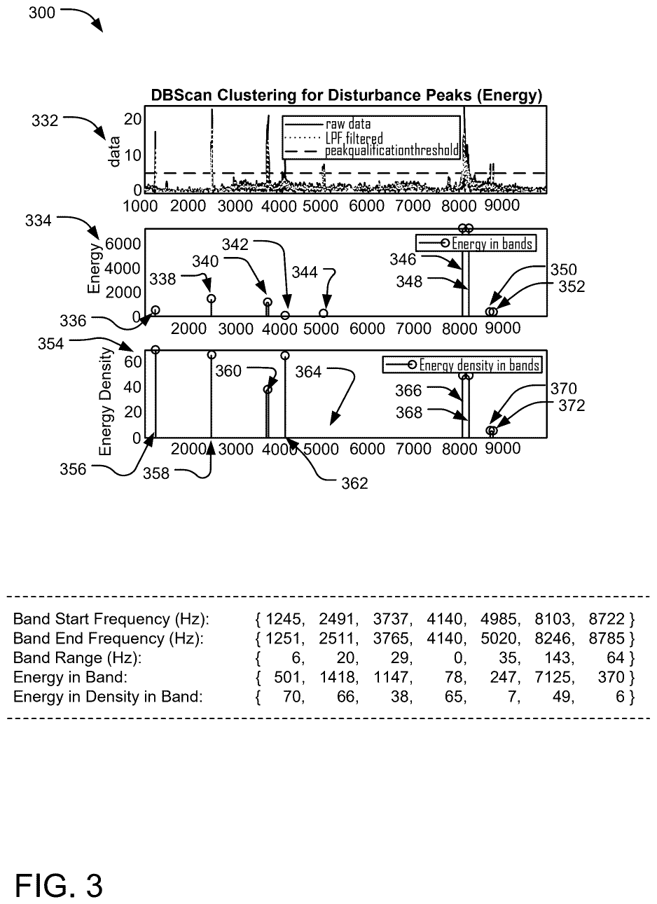

FIG. 3 illustrates an example disturbance profile 300 for a storage device. The disturbance profile 300 is generated by a servo control system based on disturbances detected at the storage device. The example disturbance profile includes a graph 332 of a DBSCAN clustering for disturbances detected at the storage device. The disturbance profile 300 includes a graph 334 of energy of disturbances that are clustered according to frequency band, for example, peak 336, peak 338, peak 340, peak 342, peak 344, peak 346, peak 348, peak 350, and peak 352 represent ten frequency bands of the disturbance profile 300 with characteristic energies. The disturbance profile 300 includes a graph 354 of the energy density of disturbances that are clustered according to frequency, for example, peak 356, peak 358, peak 360, peak 362, peak 364, peak 366, peak 368, peak 370, and peak 372 represent the ten frequency bands of the disturbance profile 300 with characteristic energy densities. The text at the bottom of FIG. 3 depicts the energy values (for graph 334) and energy density values (graph 354) for the corresponding ten frequency bands.

In some implementations, the servo control system selects the top N (e.g., eight, five, or other number N that is less than or equal to ten and greater than or equal to one) frequency bands having the greatest energy (e.g., according to graph 334) or having the greatest energy density (e.g., according to graph 354) and then select a corresponding set of N adaptive features to include in servo code to address the top N frequency bands.

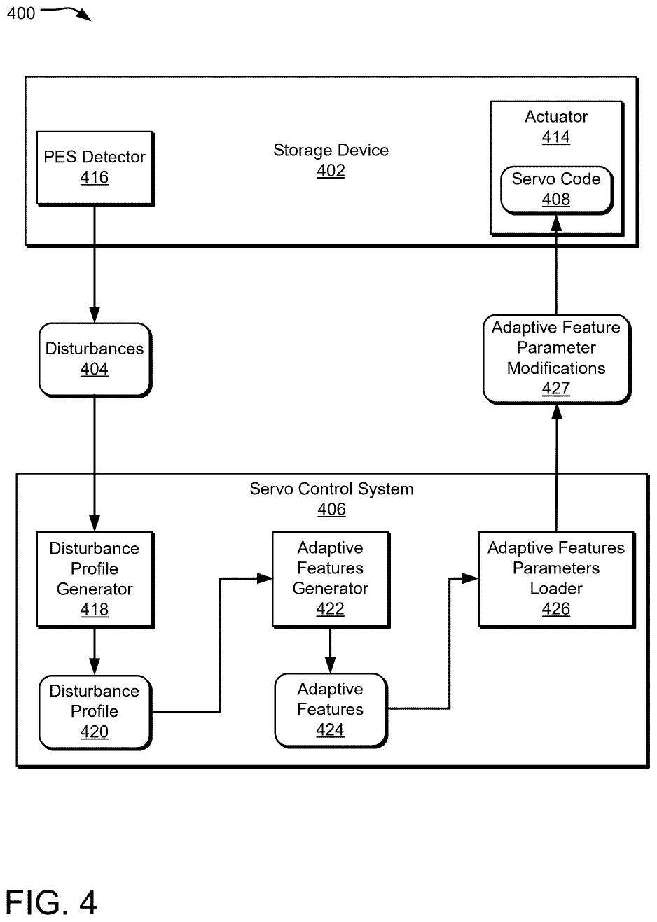

FIG. 4 illustrates an example computing environment 400 in which a servo control system 406 incorporates adaptive features parameter modifications 427 for a set of adaptive features in servo code 408 of a storage device 402 based on disturbances 404 detected at the storage device 402. The computing environment 400 includes a storage device 402 and a servo control system 406. In some implementations, the servo control system 406 is a component of the storage device 402. For example, a servo control system 406 that is a component of a deployed storage device 402 may perform an on-the-fly tuning process, determine adaptive features parameter modifications 427, and deploy the adaptive features parameter modifications 427 in the servo code 408 during the tuning process. In some implementations, the servo control system 406 is a separate system from the storage device 402. For example, a servo control system 406 that is a separate system from the storage device 402 may perform an offline tuning process and determine adaptive features 424 prior to deployment of the storage device 402.

The servo control system 406 includes a disturbance profile generator 418, an adaptive features generator 422, and an adaptive features parameters loader 426. The disturbance profile generator 418 generates a disturbance profile 420 based on the disturbances 404. In some implementations, a PES detector 416 of the data storage device 402 detect the disturbances and the adaptive features generator 422 receives the detected disturbances 404 from the PES detector 416.

The adaptive features generator 422 determines, based on the disturbance profile 420, a set of N adaptive features 424 to address a set of N top disturbances of the disturbance profile 420. For example, selecting the N top disturbances may include ranking frequency bands of the detected disturbances 404 according to energy (or energy density) and then selecting the N frequency bands with the greatest energy (or greatest energy density). The N adaptive features 424 may be selected to address the N selected frequency bands of the disturbance profile 420 based on the characteristics of the frequency bands.

The adaptive features parameters loader 426 may incorporate adaptive feature parameter modifications 427 corresponding to the set of N adaptive features 424 in the servo code 408, each adaptive feature of the set of N adaptive features 424 being configured to address a corresponding frequency band of the N selected frequency bands of the disturbance profile 420. The adaptive features parameters loader 426 deploys the adaptive feature parameter modifications 427 in the servo code 408 of the storage device 402. An actuator 414, which controls the operation of one or more read/write heads of the storage device 402, may operate the one or more read/write heads in accordance with the servo code 408 that includes the adaptive feature parameter modifications 427. For example, parameters of the adaptive features may include depth, frequency, and bandwidth that are based on the depth, frequency, and bandwidth of the disturbances of the disturbance profile for which the adaptive features are targeted. The adaptive feature parameter modifications 427 may include changing default value(s) of parameters of each of a set of default adaptive features already in the servo codes to new value(s) determined in accordance with the set of adaptive features 424 determined for the disturbance profile. The adaptive feature parameter modifications 427 may be saved in a flash memory or other memory of the storage device.

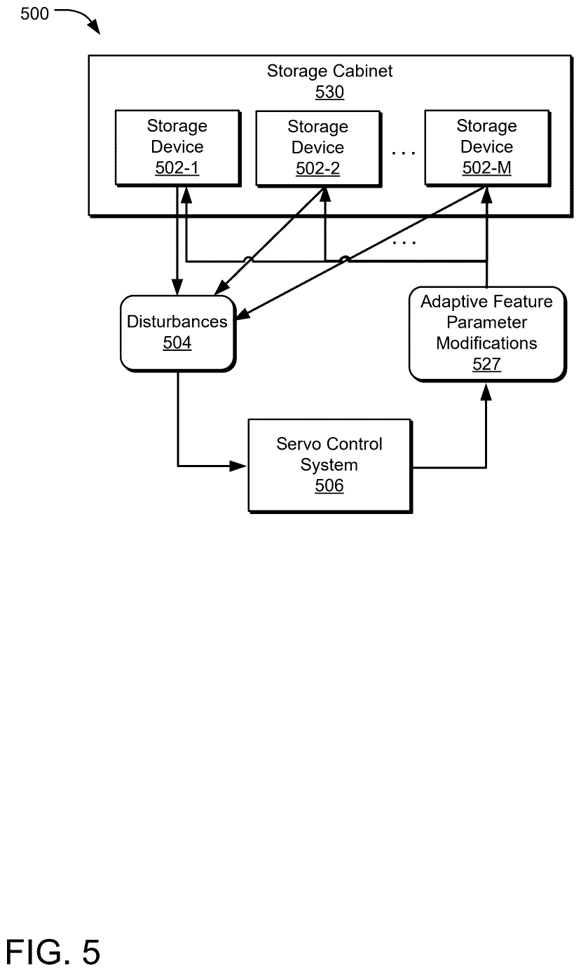

FIG. 5 illustrates an example computing environment 500 in which a servo control system 506 generates adaptive features for incorporation into servo codes of a plurality of storage devices (e.g., M storage devices 502-1, 502-2, . . . 502-M of storage cabinet 530) based on disturbances 504 at the plurality of storage devices. The computing environment 500 includes a storage cabinet 530 that includes a plurality of storage devices (e.g., M storage devices 502-1, 502-2, . . . 502-M) and a servo control system 506. In some implementations, each of one or more of the storage devices has a corresponding servo control system. For example, a servo control system 506 that is a component of a deployed storage device may perform an on-the-fly tuning process, determine adaptive features parameter modifications, and deploy the adaptive features parameter modifications in the servo code of the storage device during the tuning process. In some implementations, the servo control system 506 is a separate system from the storage devices. For example, a servo control system 506 that is a separate system from the storage devices may perform an offline tuning process to determine adaptive features prior to deployment of the storage devices.

In some implementations, the servo control system 506 performs a tuning operation on a first storage device 502-1 of the plurality of storage devices of the storage cabinet 530 to obtain disturbances 504 and to generate a disturbance profile for the detected disturbances 504 obtained during the tuning operation. The servo control system 506 then generates a set of N adaptive features to address disturbances of the disturbance profile.

The disturbances 504 may include one or more vibrations detected at the storage device 502-1 during the tuning operation. The disturbances 504 may include fixed and/or varying disturbances. The servo control system 506 may generate a disturbance profile (e.g., a disturbance spectrum) for the storage device 502-1 that describes the disturbances 504. For example, the disturbance profile may include one or more frequency zones/bands corresponding to the detected disturbances 504 that have characteristic energies or energy densities. The disturbance profile may be generated by PESs detected at the storage device 502-1.

The servo control system 506, based on the disturbance profile generated from the detected disturbances 504, selects a set of adaptive features for incorporation into servo code of one or more of the storage device 502-1 and other storage devices (e.g., applicable storage devices including one or more of storage devices 502-1 . . . 502-M) of the storage cabinet 530. The servo control system 506 incorporates the adaptive feature parameter modifications 527 into the servo code of the applicable storage devices. For example, the adaptive feature parameter modifications 527, corresponding to the adaptive features, are incorporated into the servo codes of the applicable storage devices, stored on one or more disks of the applicable storage devices. The adaptive feature parameter modifications 527 may include changing default value(s) of each of a set of default adaptive features already in the servo codes to new value(s) determined in accordance with the set of adaptive features determined for the disturbance profile. The adaptive feature parameter modifications 527 may be saved in a flash memory or other memory of the storage device.

In some implementations, the servo control systems (e.g., servo control system 506) corresponding to the M storage devices perform separate tuning operations on the M storage devices of the storage cabinet 530 to obtain corresponding disturbances specific to each storage device. For example, each of the M storage devices experiences a different disturbance and, accordingly, the disturbance profiles generated for the detected disturbances obtained during the tuning operation are different each storage device. The servo control system then determines, for each of the M storage devices, a corresponding set of N adaptive features to address disturbances of the corresponding disturbance profile. The corresponding set of N adaptive features is deployed in the corresponding servo code of the M storage devices. Accordingly, the servo code of each of the M storage devices may have a corresponding set of N adaptive features that is different from the sets of N adaptive features for other storage devices of the same cabinet that are in different slots. In some implementations, when the set of N adaptive features is determined for a particular storage device (e.g., storage device 502-1), the set of N adaptive features is deployed to (e.g., adaptive features parameters of the N adaptive features is copied to) all storage devices in the same slot as the particular storage device.

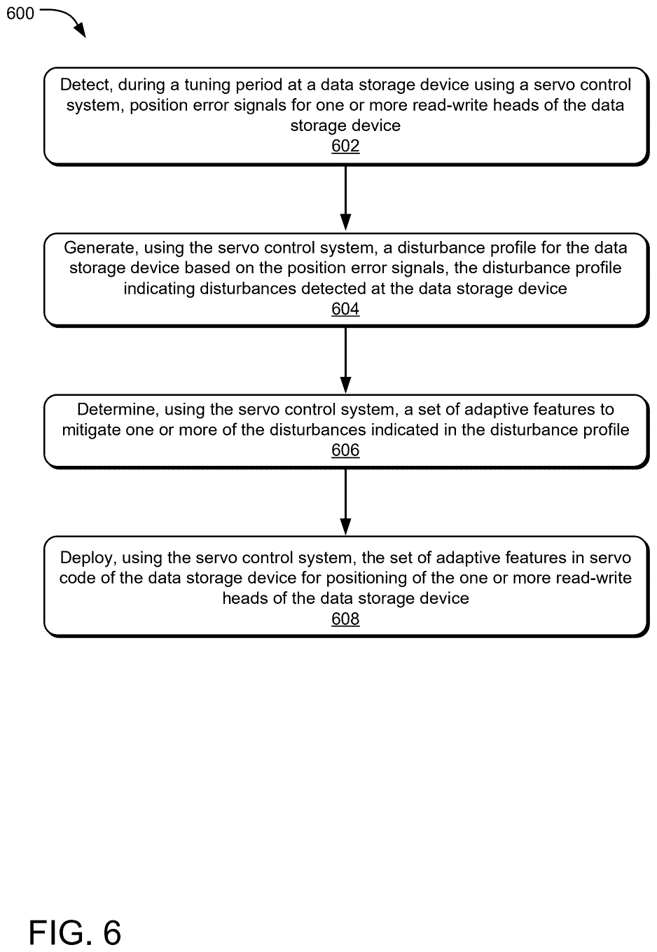

FIG. 6 illustrates examples of operations 600 for mitigating disturbances detected a storage device.

A detecting operation 602 detects, during a tuning period at a data storage device using a servo control system, position error signals for one or more read-write heads of the data storage device.

A generating operation 604 generates, using the servo control system, a disturbance profile for the data storage device based on the position error signals, the disturbance profile indicating disturbances detected at the data storage device. In some implementations, the disturbances include one or more of fixed frequency disturbances and varying frequency disturbances detected at the data storage device. In some implementations, the disturbance profile expresses one or more of a depth, a frequency, and a bandwidth of the disturbances.

A determining operation 606 determines, using the servo control system, a set of adaptive features to mitigate one or more of the disturbances indicated in the disturbance profile. In some implementations, determining the set of adaptive features comprises identifying, from the disturbance profile, a set of disturbances of a predefined number having a greatest energy or energy density and determining a corresponding adaptive feature for each disturbance of the set of disturbances to determine the set of adaptive features.

A deploying operation 608 deploys, using the servo control system, the set of adaptive features in servo code of the data storage device for positioning of the one or more read-write heads of the data storage device. In some implementations, the servo code controls operation of one or more arms of the data storage device that position the one or more read-write heads, wherein the operation of the data storage device in accordance with the set of adaptive features comprises the operation of the one or more arms in accordance with the set of adaptive features. In some implementations, subsequent to deploying the set of adaptive features, the servo control system generates a subsequent disturbance profile for the data storage device indicating subsequent disturbances at the data storage device based on subsequent position error signals detected at the data storage device during a deployment period subsequent to the tuning period, modifies one or more parameters of the set of adaptive features to generate a subsequent set of adaptive features to mitigate one or more of the subsequent disturbances indicated in the subsequent disturbance profile, and deploys the subsequent set of adaptive features at the data storage device. In some implementations, the set of adaptive features is deployed to one or more other data storage devices located within a same cabinet of the data storage device.

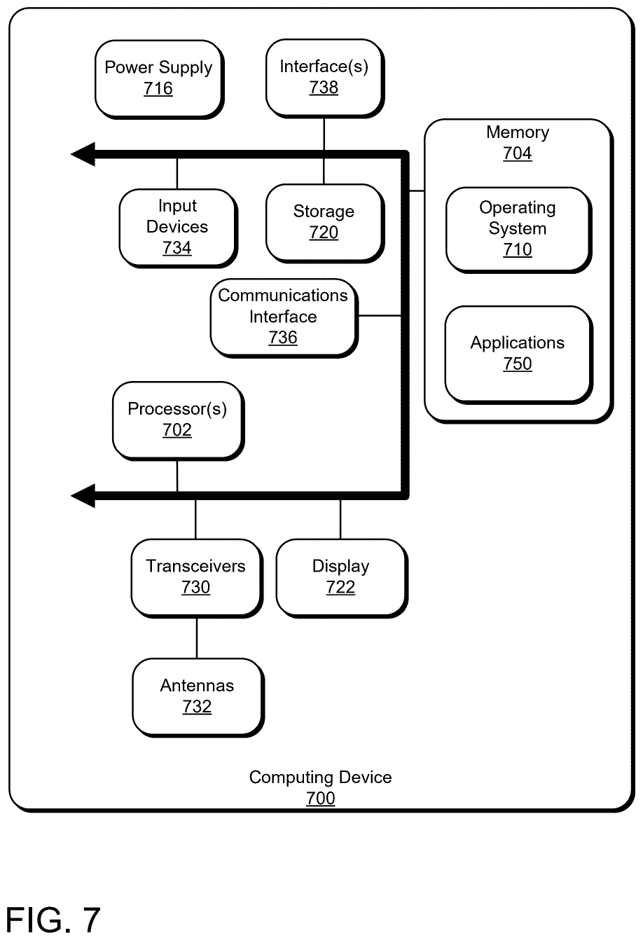

FIG. 7 illustrates an example computing device 700 for implementing the described technology. The computing device 700 may be a client computing device (such as a laptop computer, a desktop computer, or a tablet computer), a server/cloud computing device, an Internet-of-Things (IoT), any other type of computing device, or a combination of these options. The computing device 700 includes one or more hardware processor(s) 702 and a memory 704. The memory 704 generally includes both volatile memory (e.g., RAM) and nonvolatile memory (e.g., flash memory), although one or the other type of memory may be omitted. An operating system 710 resides in the memory 704 and is executed by the processor(s) 702. In some implementations, the computing device 700 includes and/or is communicatively coupled to storage 720.

In the example computing device 700, as shown in FIG. 7, one or more software modules, segments, and/or processors, such as one or more of a servo control system, a disturbance profile generator, an adaptive features generator, a servo code generator, applications 750, and other program code and modules are loaded into the operating system 710 on the memory 704 and/or the storage 720 and executed by the processor(s) 702. The storage 720 may store data (e.g., including one or more detected position error signals, disturbances, disturbance profiles, adaptive features, parameters of adaptive features, servo code, or other data) and be local to the computing device 700 or may be remote and communicatively connected to the computing device 700. In particular, in one implementation, components of a system for determining disturbances at a storage device and generating adaptive features for addressing the disturbances may be implemented entirely in hardware or in a combination of hardware circuitry and software.

The computing device 700 includes a power supply 716, which may include or be connected to one or more batteries or other power sources and which provides power to other components of the computing device 700. The power supply 716 may also be connected to an external power source that overrides or recharges the built-in batteries or other power sources.

The computing device 700 may include one or more communication transceivers 730, which may be connected to one or more antenna(s) 732 to provide network connectivity (e.g., mobile phone network, Wi-Fi®, Bluetooth®) to one or more other servers, client devices, IoT devices, and other computing and communications devices. The computing device 700 may further include a communications interface 736 (such as a network adapter or an I/O port, which are types of communication devices). The computing device 700 may use the adapter and any other types of communication devices for establishing connections over a wide-area network (WAN) or local-area network (LAN). It should be appreciated that the network connections shown are exemplary and that other communications devices and means for establishing a communications link between the computing device 700 and other devices may be used.

The computing device 700 may include one or more input devices 734 such that a user may enter commands and information (e.g., a keyboard, trackpad, or mouse). These and other input devices may be coupled to the server by one or more interfaces 738, such as a serial port interface, parallel port, or universal serial bus (USB). The computing device 700 may further include a display 722, such as a touchscreen display.

The computing device 700 may include a variety of tangible processor-readable storage media and intangible processor-readable communication signals. Tangible processor-readable storage can be embodied by any available media that can be accessed by the computing device 700 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 700. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method for mitigating disturbances detected at a data storage device, comprising: during a tuning period, detecting, at the data storage device using a servo control system, position error signals for one or more read-write heads of the data storage device; generating, using the servo control system, a disturbance profile for the data storage device based on the position error signals, the disturbance profile indicating the disturbances detected at the data storage device; determining, using the servo control system, a set of adaptive features to mitigate one or more of the disturbances indicated in the disturbance profile; and deploying, using the servo control system, the set of adaptive features in servo code of the data storage device for positioning of the one or more read-write heads of the data storage device.

Clause 2. The method of clause 1, wherein determining the set of adaptive features comprises: identifying, from the disturbance profile, a set of disturbances of a predefined number having a greatest energy or energy density; and determining a corresponding adaptive feature for each disturbance of the set of disturbances to determine the set of adaptive features.

Clause 3. The method of clause 1, further comprising: subsequent to deploying the set of adaptive features, generating, using the servo control system, a subsequent disturbance profile for the data storage device indicating subsequent disturbances at the data storage device based on subsequent position error signals detected at the data storage device during a deployment period subsequent to the tuning period; modifying, using the servo control system, one or more parameters of the set of adaptive features to generate a subsequent set of adaptive features to mitigate one or more of the subsequent disturbances indicated in the subsequent disturbance profile; and deploying, using the servo control system, the subsequent set of adaptive features at the data storage device.

Clause 4. The method of clause 1, further comprising: deploying the set of adaptive features to one or more other data storage devices located within a same cabinet of the data storage device.

Clause 5. The method of clause 1, the disturbances including one or more of fixed frequency disturbances and varying frequency disturbances detected at the data storage device.

Clause 6. The method of clause 1, the servo code controlling operation of one or more arms of the data storage device that position the one or more read-write heads, wherein the operation of the data storage device in accordance with the set of adaptive features comprises the operation of the one or more arms in accordance with the set of adaptive features.

Clause 7. The method of clause 1, wherein the disturbance profile expresses one or more of a depth, a frequency, and a bandwidth of the disturbances.

Clause 8. One or more tangible processor-readable storage media embodied with instructions for executing on one or more processors and circuits of a computing device a process for mitigating disturbances detected at a data storage device, the process comprising: during a tuning period, detecting, at the data storage device using a servo control system, position error signals for one or more read-write heads of the data storage device; generating, using the servo control system, a disturbance profile for the data storage device based on the position error signals, the disturbance profile indicating the disturbances detected at the data storage device; determining, using the servo control system, a set of adaptive features to mitigate one or more of the disturbances indicated in the disturbance profile; and deploying, using the servo control system, the set of adaptive features in servo code of the data storage device for positioning of the one or more read-write heads of the data storage device.

Clause 9. The one or more tangible processor-readable storage media of clause 8, wherein determining the set of adaptive features comprises: identifying, from the disturbance profile, a set of disturbances of a predefined number having a greatest energy or energy density; and determining a corresponding adaptive feature for each disturbance of the set of disturbances to determine the set of adaptive features.

Clause 10. The one or more tangible processor-readable storage media of clause 8, the process further comprising: subsequent to deploying the set of adaptive features, generating, using the servo control system, a subsequent disturbance profile for the data storage device indicating subsequent disturbances at the data storage device based on subsequent PESs detected at the data storage device during a deployment period subsequent to the tuning period; modifying, using the servo control system, one or more parameters of the set of adaptive features to generate a subsequent set of adaptive features to mitigate one or more of the subsequent disturbances indicated in the subsequent disturbance profile; and deploying, using the servo control system, the subsequent set of adaptive features at the data storage device.

Clause 11. The one or more tangible processor-readable storage media of clause 8, the process further comprising: deploying the set of adaptive features to one or more other data storage devices located within a same cabinet of the data storage device.

Clause 12. The one or more tangible processor-readable storage media of clause 8, the disturbances including one or more of fixed frequency disturbances and varying frequency disturbances detected at the data storage device.

Clause 13. The one or more tangible processor-readable storage media of clause 8, the servo code controlling operation of one or more arms of the data storage device that position the one or more read-write heads, wherein the operation of the data storage device in accordance with the set of adaptive features comprises the operation of the one or more arms in accordance with the set of adaptive features.

Clause 14. The one or more tangible processor-readable storage media of clause 8, wherein the disturbance profile expresses one or more of a depth, a frequency, and a bandwidth of the disturbances.

Clause 15. A computing system for mitigating disturbances detected at a data storage device, the computing system comprising: one or more hardware processors; a disturbance profile generator stored in memory and executable by the one or more hardware processors and configured to: detect, during a tuning period at a data storage device, position error signals for one or more read-write heads of the data storage device; and generate a disturbance profile for the data storage device based on the position error signals, the disturbance profile indicating the disturbances detected at the data storage device; an adaptive features generator stored in memory and executable by the one or more hardware processors and configured to determine a set of adaptive features to mitigate one or more of the disturbances indicated in the disturbance profile; and an adaptive features parameters loader stored in memory and executable by the one or more hardware processors and configured to deploy the set of adaptive features in servo code of the data storage device for positioning of the one or more read-write heads of the data storage device.

Clause 16. The computing system of clause 15, wherein the adaptive features generator is further configured to: identify, from the disturbance profile, a set of disturbances of a predefined number having a greatest energy or energy density; and determine a corresponding adaptive feature for each disturbance of the set of disturbances to determine the set of adaptive features.

Clause 17. The computing system of clause 15, the disturbance profile generator further configured to generate, subsequent to deployment of the set of adaptive features, a subsequent disturbance profile for the data storage device indicating subsequent disturbances at the data storage device based on subsequent PESs detected at the data storage device during a deployment period subsequent to the tuning period; the adaptive features generator further configured to modify one or more parameters of the set of adaptive features to generate a subsequent set of adaptive features to mitigate one or more of the subsequent disturbances indicated in the subsequent disturbance profile; and the adaptive features parameters loader further configured to deploy the subsequent set of adaptive features at the data storage device.

Clause 18. The computing system of clause 15, the disturbances including one or more of fixed frequency disturbances and varying frequency disturbances detected at the data storage device.

Clause 19. The computing system of clause 15, the servo code controlling operation of one or more arms of the data storage device that position the one or more read-write heads, wherein the operation of the data storage device in accordance with the set of adaptive features comprises the operation of the one or more arms in accordance with the set of adaptive features.

Clause 20. The computing system of clause 15, wherein the disturbance profile expresses one or more of a depth, a frequency, and a bandwidth of the disturbances.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method for mitigating disturbances detected at a data storage device, comprising:
during a tuning period, detecting, at the data storage device using a servo control system, position error signals for one or more read-write heads of the data storage device;
generating, using the servo control system, a disturbance profile for the data storage device based on the position error signals, the disturbance profile indicating the disturbances detected at the data storage device;
determining, using the servo control system, a set of adaptive features to mitigate one or more of the disturbances indicated in the disturbance profile; and
deploying, using the servo control system, the set of adaptive features in servo code of the data storage device for positioning of the one or more read-write heads of the data storage device.

2. The method of claim 1, wherein determining the set of adaptive features comprises:
identifying, from the disturbance profile, a set of disturbances of a predefined number having a greatest energy or energy density; and
determining a corresponding adaptive feature for each disturbance of the set of disturbances to determine the set of adaptive features.

3. The method of claim 1, further comprising:
subsequent to deploying the set of adaptive features, generating, using the servo control system, a subsequent disturbance profile for the data storage device indicating subsequent disturbances at the data storage device based on subsequent position error signals detected at the data storage device during a deployment period subsequent to the tuning period;
modifying, using the servo control system, one or more parameters of the set of adaptive features to generate a subsequent set of adaptive features to mitigate one or more of the subsequent disturbances indicated in the subsequent disturbance profile; and
deploying, using the servo control system, the subsequent set of adaptive features at the data storage device.

4. The method of claim 1, further comprising:
deploying the set of adaptive features to one or more other data storage devices located within a same slot of a cabinet with respect to the data storage device.

5. The method of claim 1, the disturbances including one or more of fixed frequency disturbances and varying frequency disturbances detected at the data storage device.

6. The method of claim 1, the servo code controlling operation of one or more arms of the data storage device that position the one or more read-write heads, wherein the operation of the data storage device in accordance with the set of adaptive features comprises the operation of the one or more arms in accordance with the set of adaptive features.

7. The method of claim 1, wherein the disturbance profile expresses one or more of a depth, a frequency, and a bandwidth of the disturbances.

8. One or more tangible processor-readable storage media embodied with instructions for executing on one or more processors and circuits of a computing device a process for mitigating disturbances detected at a data storage device, the process comprising:
during a tuning period, detecting, at the data storage device using a servo control system, position error signals for one or more read-write heads of the data storage device;
generating, using the servo control system, a disturbance profile for the data storage device based on the position error signals, the disturbance profile indicating the disturbances detected at the data storage device;
determining, using the servo control system, a set of adaptive features to mitigate one or more of the disturbances indicated in the disturbance profile; and
deploying, using the servo control system, the set of adaptive features in servo code of the data storage device for positioning of the one or more read-write heads of the data storage device.

9. The one or more tangible processor-readable storage media of claim 8, wherein determining the set of adaptive features comprises:
identifying, from the disturbance profile, a set of disturbances of a predefined number having a greatest energy or energy density; and
determining a corresponding adaptive feature for each disturbance of the set of disturbances to determine the set of adaptive features.

10. The one or more tangible processor-readable storage media of claim 8, the process further comprising:
subsequent to deploying the set of adaptive features, generating, using the servo control system, a subsequent disturbance profile for the data storage device indicating subsequent disturbances at the data storage device based on subsequent PESs detected at the data storage device during a deployment period subsequent to the tuning period;
modifying, using the servo control system, one or more parameters of the set of adaptive features to generate a subsequent set of adaptive features to mitigate one or more of the subsequent disturbances indicated in the subsequent disturbance profile; and
deploying, using the servo control system, the subsequent set of adaptive features at the data storage device.

11. The one or more tangible processor-readable storage media of claim 8, the process further comprising:
deploying the set of adaptive features to one or more other data storage devices located within a same slot of a cabinet with respect to the data storage device.

12. The one or more tangible processor-readable storage media of claim 8, the disturbances including one or more of fixed frequency disturbances and varying frequency disturbances detected at the data storage device.

13. The one or more tangible processor-readable storage media of claim 8, the servo code controlling operation of one or more arms of the data storage device that position the one or more read-write heads, wherein the operation of the data storage device in accordance with the set of adaptive features comprises the operation of the one or more arms in accordance with the set of adaptive features.

14. The one or more tangible processor-readable storage media of claim 8, wherein the disturbance profile expresses one or more of a depth, a frequency, and a bandwidth of the disturbances.

15. A computing system for mitigating disturbances detected at a data storage device, the computing system comprising:
one or more hardware processors;
a disturbance profile generator stored in memory and executable by the one or more hardware processors and configured to:
detect, during a tuning period at a data storage device, position error signals for one or more read-write heads of the data storage device; and
generate a disturbance profile for the data storage device based on the position error signals, the disturbance profile indicating the disturbances detected at the data storage device;
an adaptive features generator stored in memory and executable by the one or more hardware processors and configured to determine a set of adaptive features to mitigate one or more of the disturbances indicated in the disturbance profile; and
an adaptive features parameters loader stored in memory and executable by the one or more hardware processors and configured to deploy the set of adaptive features in servo code of the data storage device for positioning of the one or more read-write heads of the data storage device.

16. The computing system of claim 15, wherein the adaptive features generator is further configured to:
identify, from the disturbance profile, a set of disturbances of a predefined number having a greatest energy or energy density; and
determine a corresponding adaptive feature for each disturbance of the set of disturbances to determine the set of adaptive features.

17. The computing system of claim 15,
the disturbance profile generator further configured to generate, subsequent to deployment of the set of adaptive features, a subsequent disturbance profile for the data storage device indicating subsequent disturbances at the data storage device based on subsequent PESs detected at the data storage device during a deployment period subsequent to the tuning period;
the adaptive features generator further configured to modify one or more parameters of the set of adaptive features to generate a subsequent set of adaptive features to mitigate one or more of the subsequent disturbances indicated in the subsequent disturbance profile; and
the adaptive features parameters loader further configured to deploy the subsequent set of adaptive features at the data storage device.

18. The computing system of claim 15, the disturbances including one or more of fixed frequency disturbances and varying frequency disturbances detected at the data storage device.

19. The computing system of claim 15, the servo code controlling operation of one or more arms of the data storage device that position the one or more read-write heads, wherein the operation of the data storage device in accordance with the set of adaptive features comprises the operation of the one or more arms in accordance with the set of adaptive features.

20. The computing system of claim 15, wherein the disturbance profile expresses one or more of a depth, a frequency, and a bandwidth of the disturbances.
